(19) United States
(12) Patent Application Publication
(10) Pub. No.: US 2002/0085515 A1
(43) Pub. Date: Jul. 4, 2002

(54) Object specific information relaying system

(76) Inventors: Christopher O. Jaynes, Lexington, KY (US); Stephen B. Webb, Lexington, KY (US)

Correspondence Address: DYKAS, SHAVER & NIPPER, LLP, P O BOX 877, BOISE, ID, 83701-0877, US

(21) Appl. No.: 09/752,214

(22) Filed: Dec. 28, 2000

(51) Int. Cl. H04L 12/66

(52) U.S. Cl. 370/329; 370/352; 370/401

(57) ABSTRACT

An object specific information relaying system which includes a beacon which is attached to a physical object, an information receiving device which receives information about the physical object, signal transmitters and receivers in both beacon and information receiving device, an internet contacting unit, a system server, and an internet web page associated with each physical device. A signal from the information receiving device triggers an identifying signal from the beacon, which is transmitted to the internet. The system server associates the identifying signal with a web page with information specific to the physical device, and transmits the information to the information receiving device.

### BACKGROUND OF THE INVENTION

1. Field of the Invention

The present invention generally relates to wireless communications, and more particularly to wireless communications systems for relaying information related to an object to a user, and to a hand held device.

2. Background Information

Advances in electronic technology have resulted in improved technologies in many areas. Computers have become faster, and have memory devices which store larger and larger amounts of memory at a reasonable price. These technological advances have resulted in increasingly competent desk top computers, lap top computers, and hand held computers, also known as personal digital assistants, or PDAs. Another class of machines which has improved tremendously in recent years have been cell phones. Current technology offers wireless internet connections by cell phones, PDAs, and laptop computers to send and retrieve e-mail, to browse internet web sites, and to download information from the internet. Further advances are expected in the technologies for each of these devices.

Advances in the technology of transistors have also occurred. This has resulted in transistors which can be utilized to send and receive information wirelessly, and which require very little power for this transmission.

However, the integration of these technologies would provide a functionality which is not present in today's offerings. What is needed is a system which integrates these technologies and provides information to a user which is relevant to a specific physical object in the vicinity of the user. This system would enable point of sale purchases and connect the user through the internet to information sources and to currency tracking systems, such as bank accounts, credit cards and debit cards.

### SUMMARY OF THE INVENTION

These and other objects are accomplished by an object specific information relaying system. The object specific information relaying system includes several components, one of which is a beacon device. A beacon device is a small reprogrammable device that can be placed on or attached to a physical object. The physical object may be a wall, a door, a person when worn as a lapel pin, and may also be a sign, a gas pump, a parking meter, a vehicle, or any number of physical objects. The beacon device includes a power source, and has a receiver for receiving a transmit signal and a transmitter for sending a signal. Receipt of the transmit signal initiates transmission of a response signal. The beacon device has a response signal transmitter for transmitting the response signal.

The system also includes one or more information receiving devices. The information receiving devices have a transmission unit for sending the transmit signal. They also have a receiving unit for receiving the response signal sent by the beacon device. A display device is also provided which displays information relevant to the physical object. This display device can simply display information as received, but in another configuration of the device would also serve as an interactive user interface. For instance, choices might be presented for the user to choose which options he desired, and information might be requested from the user about method of payment, or other required information. The system also includes an internet accessing unit. This unit would send an access signal to an internet site and would download information relevant to the physical object contacted by the information receiving device. The access signal would contain information which enabled the transfer of information relative to the physical object.

The information receiving device could be a desktop computer, a cell phone, a lap top computer, a vehicle based computer, a PDA or some similar computing device.

One way in which this system would work would be by the use of a PDA as the information receiving device, with the internet accessing unit built into the PDA. Another version of the invention could have the internet accessing unit built into the beacon device and would work similarly to the first version. The user would send a transmit signal to the beacon device using the infrared (IR) signal of the PDA. In this case, the infrared transmitter would serve as the transmission unit, and the infrared signal would be the transmit signal. The beacon device would receive the transmit signal and transmit a beacon identification, or I.D., number via the infrared port of the PDA. This beacon I.D. number would then be forwarded to an internet server via wireless TCP/IP built into the user's PDA. The system server would then resolve the incoming beacon I.D. number and determine the corresponding universal resource locator (URL) to transmit to the user's PDA.

A more specific example of how this works is if the physical object were a sign at a zoo, located in front of the lion's cage. When contacted by the user's PDA, the beacon device on the lion's cage sign would transmit it's I.D. number to the PDA. The PDA would relay that beacon I.D. number to the system server. The system server would identify what web page corresponds to the beacon I.D. number, and would transmit to the user's PDA information about the lion. As the user walked through the zoo, he could access specific information about any animal that he saw, based on contacting the beacon device associated with that animal's cage, and receiving information specific to that animal. Another example would be if the physical objects are trucks, and the information receiving device is a desktop computer at a weigh station. Information specific to each truck, possibly including its driver, point of origin, destination, weight, load, hazard class of the load, and signage requirements, would be downloaded from the internet to the information receiving device when the beacon was signaled. A bill for highway use would then be sent to the trucking company or owner.

This would replace the present requirement for the driver to stop his truck and enter the weigh station to enter this information.

Other situations in which information specific to a physical object could be obtained might be when the user wanted to obtain information about items for sale in a store, cars for sale on a car lot, on a self guided nature walk, at informational signs in parks, at historical markers on highways, from fellow attendees at a seminar, and many other situations.

In a second version of the device, the internet accessing unit is part of the beacon device. Information specific to the physical object which is associated with the beacon device would originate from the system server on the internet, and might be downloaded upon receipt of the transmit signal. It might also be downloaded and stored in memory at an earlier date and then transmitted to the information receiving device when signaled. If the message was to be downloaded and stored on the beacon device, a memory means would be required in the beacon device for storage of information.

The information transmitted to the information receiving device could take many forms. It could take the form of text based information, audio information, graphical based information, and each of these three combined. The graphical based information could include still photos, as well as motion pictures.

Although the example above utilizes a PDA with an infrared signal as the information receiving device and the method by which signals are transmitted, other devices and signals types are also possible. The signal receiving device can be a hand held computing device, a personal computer, cell phone, a vehicle based computer, or other devices with similar capabilities. The signal sent can be the infrared signal mentioned above, which is currently utilized with PDAs, or could also be optical, electrical, microwave, or other types of signals. The power source on the beacon device can be AC or DC voltage or could also be in the form of a battery, with our without a solar cell attached to the battery. The response signal can be a beacon I.D. number, or it can be an authorization code of some kind which authorizes access by the internet access unit to a system web site.

One possible function of the object specific information relaying system is to enable point of sale transactions. One way in which this could work using the above components is described below. When a user parks his car in a downtown parking lot, he uses a PDA as an information receiving unit to send a signal to a beacon device on the parking meter. Upon receipt of the transmit signal, the beacon device on the parking meter transmits a beacon I.D. number to the PDA. The PDA then transmits the beacon I.D. number to a system web site. The system web site offers the user several options, which are transmitted wirelessly to the PDA. The options can be how much money the user would like to deposit in an account for use of the parking space adjacent to the parking meter, and how the user would like to pay, from a bank account, a credit card account, a debit account, or by an online payment service, such as Paypal. The user might choose to enter $3.00, which would equate to three hours of use at the parking meter. Upon entering this information, the information would be transferred to the system server on the internet. Included with the information concerning how much money to credit to the parking meter, would be the user's identification code and a password which he entered at the PDA. With this information, the system server would contact the funds transferring account which had been authorized by the user, and transfer $3.00 from the user's bank account or credit card, and move that money into an account of the system server. Once the system server noted that the transfer had taken place, a confirmation signal would be sent to the user's PDA. The user's PDA would then transmit this confirmation signal to the parking meter, either by the user manually pressing the confirmation button or by the PDA automatically transmitting it. Once the confirmation signal was received by the parking meter, the parking meter would behave as if $3.00 had been deposited into it. The user could park his car without fear of a parking ticket for the next three hours. The account he selected would have been debited $3.00 for this transaction. The server and its associated bank account would have been credited with $3.00.

In addition to the basic functionality of transmitting location specific information to a handheld computer/PDA/cellular phone or other communication device, the Beacon can receive commands from the computing device. This would normally involve an authentication step where the computing device collects the necessary information (the command the user wishes to issue, the beacon device information, etc.) and sends it to a remote server machine. The server machine validates the users command, and issues an encrypted command string which is then relayed to the Beacon device. This command string may be relayed via the handheld computer, or through a direct internet connection to the Beacon. Only after the Beacon device has successfully decrypted and validated the command string will it begin to execute the command.

Several applications for such functionality have been developed. One such example is to facilitate purchases from a vending machine. The user would aim their personal computing device at the vending machine, indicate how much money they wanted to add to the machine, and then make their selection as usual. This process would involve the portable communication device issuing a request to a centralized server, where the server would then debit the users account, and issue the encrypted command back to the Beacon device (either directly over the internet, or through the users PDA). The vending machine would then decrypt the message and perform the appropriate action. This action could be as simple as signaling the vending machine to add $1 to it's current total, or merely pointing at the candy bar the user wants to purchase, and depressing a “purchase” button on a PDA.

A similar application involves paying for parking at a parking garage or meter. A beacon is located at the entrance and exit to the parking garage. The user communicates with the appropriate beacon device upon entering the parking garage. Upon exiting the parking garage, a central computer charges the customer account the appropriate amount. The exit gate is lifted once the Beacon can confirm payment confirmation. Alternatively a user could park at a metered space. The user could either transfer a set amount of money to the meter, or could be billed based on the total time interval.

There are two fundamental ideas that the beacon is based on. First, the beacon provides high functionality while retaining its simple design. It does this by offloading complicated tasks, such as networking, by using the facilities provided by the portable communication device (PDA) and the wireless networking infrastructure (internet). It uses encryption technology to validate all transactions, thus avoiding issues related to using untrusted interconnection. By offloading the networking component, the beacon is able to remain small, inexpensive and consume little power while providing advanced functionality.

Second, the beacon allows various payment and access mechanisms to be controlled by a single device. The combination of a handheld computer and application program, beacon device, and centralized servers connected to the internet enables a single device (handheld computing device) to take the place of various authentication/payment devices. For instance you could pay for groceries, gain access to your office, and register on the waiting list at a restaurant, all by aiming your personal computing device at the appropriate Beacon device. This is accomplished not by assimilating various services into one device, but rather by providing the infrastructure (beacon devices, centralized servers) which allows one device to act in place of the various services. This is fundamentally different than a business decision which combines a frequent flyer card, long distance calling plan and credit card into one account.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a diagram of the system in which a PDA connects to the internet.

FIG. 2 is a diagram of the operation of the system when the beacon device connects to the internet.

FIG. 3 is a diagram of the functioning of the system when used with a vendor device.

FIG. 4 is a logic diagram of the beacon device.

FIG. 5a is a logic diagram of the beacon software

FIG. 5b is a logic diagram of the information receiving device software

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

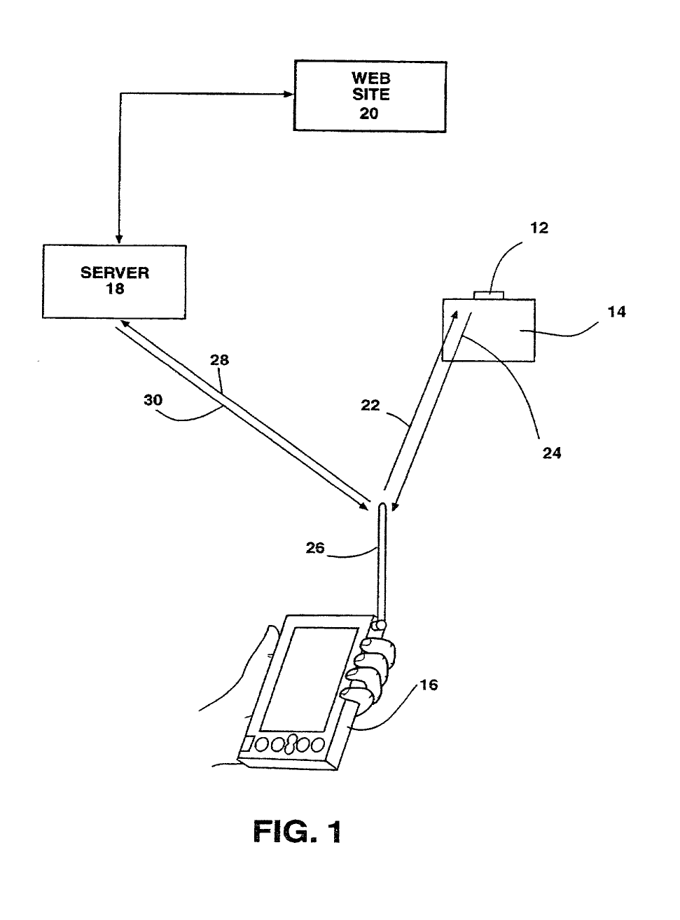

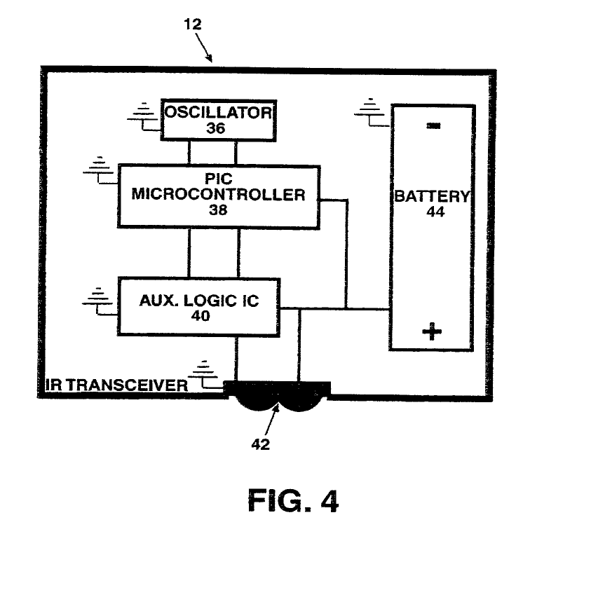

The device of the invention is further depicted in FIGS. 1 through 5b. FIG. 1 shows a preferred embodiment of the information relaying system. In this embodiment, the information receiving device is shown as a PDA, although it could be a cell phone, a lap top computer, a desk top computer, a vehicle based computer, or another similar computing device. The object specific relaying system 10, as shown in FIG. 1 functions when the user activates the information receiving device 16 to send a transmit signal 22 to a beacon 12 which is located on a physical object 14. The components of the beacon 12 are further illustrated in FIG. 4, which will be discussed below. The beacon 12 receives the transmit signal 22 from the PDA 16, and sends a response signal 24 to the PDA. In this depiction of the preferred embodiment, both the transmit signal 22 and the response signal 24 are infrared beams, a technology which is currently used in PDA'S. Obviously, other types of signals could be sent and received, including optical signals, any electromagnetic signals, audio signals, and any suitable signal transmission and reception technology. The PDA 16 is shown as having an antenna 26 for wireless transmission of signals. Using the antenna 26, the PDA 16 would send information to a system server 18 via an access signal 28. The access signal 28 could contain information which had been received from the beacon 12 relevant to the physical object 14, such as an identification number, or an authorization code. Upon receipt of the access signal 28, the system server 18 processes the access signal and associates the information therein, such as an identification number, with a specific web site 20, or a Uniform Resource Location (URL). Information from the chosen URL 20 would be transmitted to the system server 18 and back to the antenna 26 of the PDA 16 in an information signal 30. The end result of this transmission might be displaying information on the PDA which is relevant and specific to the physical object 14.

This configuration of the invention incorporates within it several ideas which present significant advantages over the prior practice. First, the beacon device 12 provides high functionality while retaining a simple design. It does this by not attempting to perform complicated tasks such as connecting with the internet. Instead it uses devices which already have the ability to perform these functions, such as a PDA, cell phone, or laptop. The PDA can provide a highly functional portable communication device and connect to the wireless networking infrastructure of the internet. By not assuming the networking function of the system, the beacon is able to remain small, inexpensive, and consume little power while providing the advanced functionality needed for the system. The system also uses encryption technology to validate all transactions, thus avoiding issues relating to using non-secure interconnections.

Second, the beacon allows various payment and access mechanisms to be controlled by a single device. The combination of a hand held computer (the PDA) and application program, a beacon device, and centralized servers connected to the internet, enables a single device (the PDA) to take the place of various authentication and payment devices. As an example, a user could pay for groceries, gain access to his office, register on the waiting list of a restaurant, obtain products from a vending machine, authorize payment to a parking meter, all by aiming a PDA or other information receiving device at a beacon, and pressing a “purchase” button or its equivalent. This is accomplished not by combining various services and functions into one device, but rather by using existing infrastructure PDA's and wireless internet connection, with a simple beacon device which triggers and directs their use in regards to supplying information for a particular physical object. This is fundamentally different than a device which combines many functions, such as combining a frequent flyer card, long distance calling plan, and a credit card into one device or account.

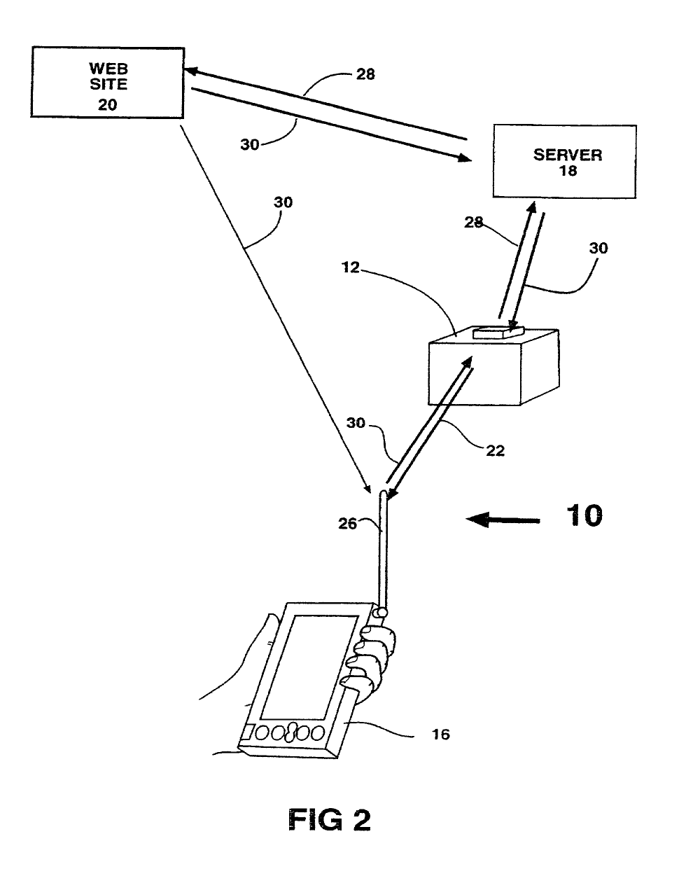

FIG. 2 shows an alternate preferred embodiment of the invention. In this embodiment of the invention, the PDA 16 sends a transmit signal 22 to the beacon device 12. The beacon device 12 sends an access signal 28 to the system server 18. The system server 18 processes the access signal 28 from the beacon device 12 and based on information within the access signal accesses a web site or URL 20. Information from the URL 20 is then routed back to the system server 18, and sent to the beacon device 12 in an information signal 30. The information signal 30 is then routed to PDA 16. Alternately, information signal 30 can be routed from URL 20 directly to the antenna 26 of the PDA 16.

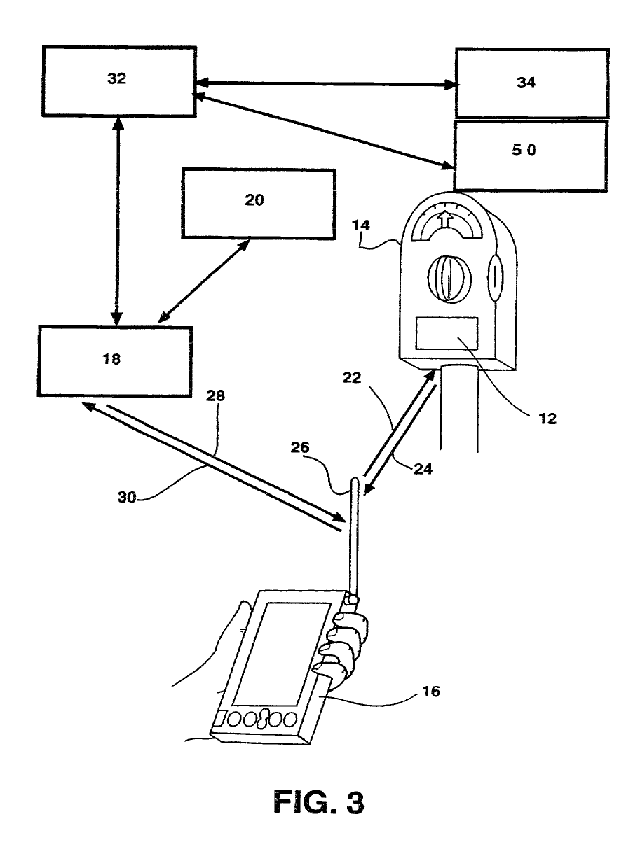

A third preferred embodiment of the object specific information relaying system is shown in FIG. 3. FIG. 3 shows an example of the system used with a physical device 14 which is a parking meter. Obviously, this version of the system could be utilized with any kind of vending machine such as a machine which dispensed tickets to an event, a machine which dispensed items from a vending machine, a machine at the exit of a commercial parking lot for paying for parking at an airport or other parking facility, a device for paying for gasoline at a filling station, or in any vending situation.

The configuration shown in FIG. 3 uses a PDA as the information receiving device 16. Obviously, other devices could be utilized such as a lap top computer, a cell phone, a desk top computer, a vehicle based computer, or any other suitable computing device. The parking meter 14 has attached to it a beacon device 12. When a person wished to use a parking space and to credit money to the parking meter, the user would send a transmit signal 22 from the PDA to the beacon device. The beacon device would respond by sending a response signal 24 to the PDA. The response signal would contain an identification number or an access code for the particular parking meter. Once the response signal 24 was received by the PDA, the access signal 28 would be sent from the antenna 26 of the PDA 16 to the system server 18. The system server 18 would utilize information from the response signal, such as an identification number, and either send an information signal 30 back to the PDA 16, or first connect with a URL 20, and send information from the URL 20 back to the PDA 16. Further Interactions between the PDA and the system server 18 could include interactive choices by the user concerning how much money he wanted to credit the vendor with, and what source the money should come from, such as from his bank account, from a credit card, or for an online transaction service such as Paypal or Bill Point. Such a payment service is shown as Box 32 of FIG. 3. The payment service 32 would connect with the accounts of the user and the vendor, and credit the account 50 of the vendor with the specified sum, and debit the account 34 of the user with the sum he had chosen. This flow if money would operate with the system configuration of FIG. 1 or FIG. 2.

FIG. 4 is a logic diagram of the beacon device. Although a device which performs the functions described by the claims can take many alternate forms, a preferred embodiment is shown in FIG. 4. The beacon device 12 includes an oscillator 36, a microcontroller 38, a logic integrated circuit 40, an IR transceiver 42, and a battery 44.

The oscillator 26 interacts with the PIC microcontroller 38 by providing it with a timing signal. When the microcontroller 38 is in shut down mode, such as when waiting for a connection to be initiated, the oscillator is inactive.

The preferred microcontroller is a brand called a PIC microcontroller. The microcontroller is a central piece of the system, containing all the executable code for providing the beacon functionality. This includes the beacon ID number, sequence number, and encryption algorithm if desired, and communications code. These would all be stored internally to the PIC microcontroller chip 38. The logic integrated circuit (IC) 40 converts the short (1.5 microsecond) pulses emitted by the IR receiver module into longer (1 full bit period) pulses to allow the PIC microcontroller 38 to correctly read the incoming pulse. This logic IC 40 could be in a number of configurations to provide this functionality. One configuration would be as a monostable multivibrator, also called “One Shot” or “Pulse Stretcher.” A similar system could be built which did not utilize this component, but the preferred embodiment would include one.

The IR transceiver 42 interacts with the logic IC 40 by supplying an output signal, consisting of short pulses, to signify the start of a “one” bit period. It is also connected directly to the PIC microcontroller 38 for a transmit signal. An additional “shut down” connection to the PIC microcontroller 38 enables the PIC microcontroller to put the IR transceiver 42 into a “low power” state to conserve battery power.

The battery 44 is connected to the components as follows. The oscillator 36 connects to a common ground plane and is thereby connected to the negative side of the battery 44. The PIC microcontroller 38 connects to both the positive and the negative sides of the battery. The logic IC 40 connects to the positive and the negative sides of the battery. The logic IC 40 could also be connected to the PIC microcontroller 38 to get power, as an optional configuration. In this configuration, when the PIC microcontroller 38 went into shut down mode, the logic IC 40 would also be shut off. The IR transceiver 42 gets power from the battery through the positive connection and the negative ground plane connection of the battery.

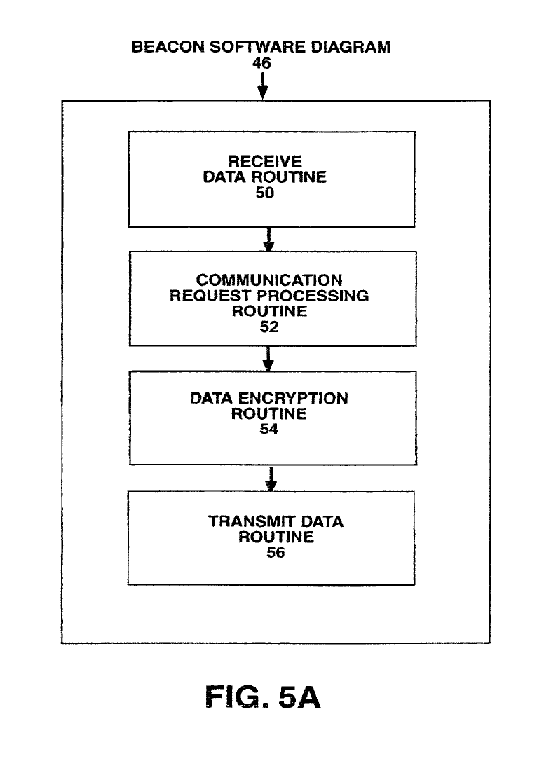

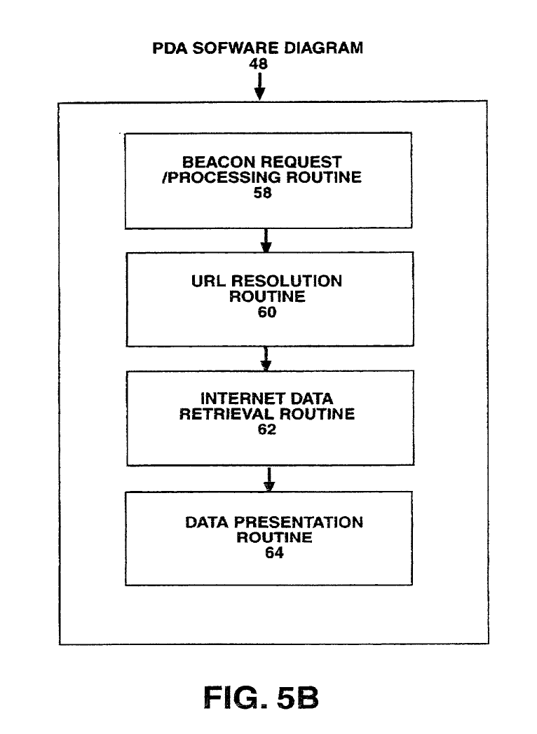

The software components of the preferred embodiment of the invention is shown in FIGS. 5a and 5b. FIG. 5a shows the Information Receiving Device Software, which begins at block 50, the “Receive data routine.”

1. The “Receive data routine” shown at block 50 is a piece of software on the PIC microcontroller of the information receiving device 16 that is responsible for receiving incoming communication attempts. It passes received data to the second stage for processing.

2. “Communication request processing routine”, block 52, is a portion of the PIC software which analyzes an incoming data stream and identifies valid communication requests from client software.

3. “Data encryption routine” Upon receiving a valid request, the data encryption routine shown at block 54 is invoked to encrypt the Beacon ID number in a binary string.

4. “Transmit data routine,” shown at block 56, is a routine which is called after the encrypted data string is ready to be transmitted.

The logic of the PDA Software is shown in FIG. 5b, and begins with block 58, the Beacon request/processing routine.

1. The “Beacon request/processing routine” at block 58 is software written for a PDA device which initiates interaction with the Beacon device. All communication with the beacon device is handled by this routine.

2. The “URL resolution routine” communicates the encrypted string (received from the beacon in step 1) to the system servers 18. The string is then decrypted (on the system server 18) and associated with a URL 20. URL data is handled by the URL resolution routine. The URL can be a web address, IP address, or other address which can be used to provide the user with Internet based information.

3. After receiving data from the URL 20 (or other data location information) the “Internet Data retrieval routine” 62 is used to handle all request/verification/receipt processes necessary in order to retrieve the desired information. An example of an “Internet data retrieval routine” 62 is FTP (File Transfer Protocol) and HTTP (Hypertext Transfer Protocol). The data retrieval routine is whatever protocol is appropriate for retrieving a given type of data.

4. After data has been retrieved, it is presented to the user by means of the “Data Presentation routine” 64. The actions of this routine depend on the content type being retrieved. In the case of an HTML type document, the appropriate HTML viewer routine would be used. In the case of an FTP type request, the data may be saved to the long term storage of the PDA device. The data presentation is made appropriate for the given type of data.

While there is shown and described the present preferred embodiment of the invention, it is to be distinctly understood that this invention is not limited thereto but may be variously embodied to practice within the scope of the following claims.

From the foregoing description, it will be apparent that various changes may be made without departing from the spirit and scope of the invention as defined by the following claims.

I claim:

1. An object specific information relaying system, which comprises:
one or more beacon devices, each associated with a physical object, for sending a signal which contains information relevant to said physical object, said beacon device comprising;
a power source;
a transmit signal receiver for receiving a transmit signal, which initiates transmission of a response signal;
a response signal transmitter, for transmitting said response signal;
one or more information receiving devices, which comprises;
a transmit signal transmission unit, for sending a transmit signal which initiates transmission of a response signal;
a response signal receiving unit for receiving said response signal with first information relevant to said physical object;
a display device for displaying said information relevant to said physical object; and
an internet accessing unit, for sending an access signal to an internet site and downloading information relevant to said physical object as a result of an access signal having been sent.

2. The object specific information relaying system of claim 1, in which said internet accessing unit is part of said one or more beacon devices.

3. The object specific information relaying system of claim 1, in which said internet accessing unit is part of said one or more receiving devices.

4. The object specific information relaying system of claim 1, in which said internet information is downloaded upon the receipt of said transmit signal.

5. The object specific information relaying system of claim 1, in which said beacon device includes memory means for storing internet information prior to transmitting said internet information.

6. The object specific information relaying system of claim 5, in which said internet information is periodically downloaded at preselected intervals, and stored in said memory means for later transmission.

7. The object specific information relaying system of claim 1, in which said information receiving device further comprises a memory means for storing information received by transmission.

8. The object specific information relaying system of claim 1 in which said display of information is in the form of text based information.

9. The object specific information relaying system of claim 1 in which said display of information is in the form of audio information.

10. The object specific information relaying system of claim 1 in which said display of information is in the form of graphical based information.

11. The object specific information relaying system of claim 1 in which said display of information is in the form of a combined media presentation.

12. The object specific information relaying system of claim 1, in which said display of information is interactive with a use, and further exchanges of information from said information receiving device and said internet website is enabled.

13. The object specific information relaying system of claim 1 in which said signal receiving device is handheld computing device .

14. The object specific information relaying system of claim 1 in which said signal receiving device is personal computer.

15. The object specific information relaying system of claim 1 in which said signal is transmitted as an infrared signal.

16. The object specific information relaying system of claim 1 in which said signal is transmitted as a cell phone technology signal.

17. The object specific information relaying system of claim 1 in which said signal is an optical signal.

18. The object specific information relaying system of claim 1 in which said beacon device power source is a battery.

19. The object specific information relaying system of claim 1 in which said beacon device power source is a solar cell.

20. The object specific information relaying system of claim 1 in which said response signal is a code which authorizes access by said internet access unit to a website.

21. The object specific information relaying system of claim 20 in said web site enables a transfer of funds from a user account to a vendor account.

22. The object specific information relaying system of claim 21 in which said transfer of funds enables a payment complete signal to be sent to said internet access unit, which upon receipt of said payment complete signal relays said payment complete signal to said beacon device, which enables a vending transaction.

23. An object specific information relaying system, which comprises:
one or more beacon devices, each associated with a physical object, for sending a signal which contains information relevant to said physical object, said beacon device comprising;
a power source;
a transmit signal receiver for receiving a transmit signal, which initiates transmission of an information signal;
an internet accessing control logic, for accessing an internet site and downloading internet information from said internet site;
a memory means for storing internet information prior to transmitting said internet information;
an information transmitter, for transmitting said internet information in an information signal;
one or more information receiving device which is are handheld computing devices which comprises;
a transmit signal transmission unit, for sending a transmit signal which initiates transmission of an information signal;
an information signal receiving unit for receiving said information signal with internet information relevant to said physical object;
a display device for converting said information signal into a display of information relevant to said physical object;
a memory means for storing information received by transmission.

24. An object specific information relaying system, which comprises:
one or more beacon devices, each associated with a physical object, for sending a signal which contains information relevant to said physical object, said beacon device comprising;
a power source;
a transmit signal receiver for receiving a transmit signal, which initiates transmission of a response signal;
a response signal transmitter, for transmitting a response signal containing coded information which authorized access to a website;
one or more information receiving device which is are handheld computing devices which comprises;
a transmit signal transmission unit, for sending a transmit signal which initiates transmission of an information signal;
a response signal receiving unit for receiving said response signal from said beacon device;
a display device for display of information relevant to said physical object;
a memory means for storing information received by transmission;
an internet access unit, for sending an access signal to an internet site and downloading information relevant to said physical object as a result of said access signal having been sent;
an internet site with information relevant to said physical object, which enables a transfer of funds from a user account to a vendor account upon receipt of said coded information and user authorization; wherein
said transfer of funds enables a payment complete signal to be sent to said internet access unit, which upon receipt of said payment complete signal relays said payment complete signal to said transmission unit, which transmits said payment complete signal to said beacon device, which enables a vending transaction.

25. A method of communicating object relevant information which comprises the steps of:
mounting one or more beacon devices on one or more physical objects, for sending a signal which contains information relevant to said physical object, said beacon device comprising;
a power source;
a transmit signal receiver for receiving a transmit signal, which initiates transmission of an information signal;
an internet accessing control logic, for accessing an internet site and downloading internet information from said internet site;
a memory means for storing internet information prior to transmitting said internet information;
an information transmitter, for transmitting said internet information in an information signal;
using one or more information receiving devices to access information from said beacon devices, in which said information receiving devices are handheld computing devices, each of which comprise;
a transmit signal transmission unit, for sending a transmit signal which initiates transmission of an information signal;
an information signal receiving unit for receiving said information signal with internet information relevant to said physical object;
a display device for converting said information signal into a display of information relevant to said physical object;
a memory means for storing information received by transmission; wherein the method further includes the steps of;
sending a transmit signal from said transmission unit of one or more of said information receiving devices, to said transmit signal receiver of one or more of said beacon devices;
accessing an internet site and downloading internet information to said one or more beacon devices;
transmitting said internet information in an information signal to said one or more information receiving devices;
receiving said information signal in said information receiving devices;
converting said information signal into a display of information; and
displaying said display of information in one or a combination of text, audio, video, or graphical formats.
